(19) United States
(12) Patent Application Publication
(10) Pub. No.: US 2003/0006539 A1
(43) Pub. Date: Jan. 9, 2003

(54) Gas spring

(76) Inventors: James Bertram, Quincy, SC (US); Feroz Ahmed, Florence, SC (US); Kenneth L. Hasty, Marion, SC (US); Jack R. Roach, Florence, SC (US)

Correspondence Address: John J. Held, Esq., McAndrews, Held & Malloy, Ltd., 34th Floor, 500 West Madison Street, Chicago, IL, 60661, US

(21) Appl. No.: 10/228,512

(22) Filed: Aug. 27, 2002

Related U.S. Application Data
(62) Division of application No. 09/787,615, filed on Jul. 3, 2001.
Application No. 09/787,615 is a 371 of international application No. PCT/US00/22556, filed on Aug. 17, 2000.
(60) Provisional application No. 60/149,754, filed on Aug. 19, 1999.

(51) Int. Cl. F16F 5/00

(52) U.S. Cl. 267/120; 267/118

(57) ABSTRACT

A multiple stop gas spring that has a second or stop piston assembly in addition to a metering piston assembly, connected and movable with the gas spring shaft. The stop piston assembly is preferably spaced axially from the metering piston assembly. The stop piston assembly may be utilized to stop movement of the shaft in one direction at preselected position(s) along the shaft's normal stroke, and also, or alternatively, to cause the shaft movement in the one direction to slow incrementally to a cushioned stop when the shaft approached the end of its stroke. The shaft may move in the other direction without any impediment to its movement or may stop in both directions.

### CROSS REFERENCE TO RELATED APPLICATIONS

The present application is based on, and claims priority from, U.S. provisional application Serial No. 60/149,754, filed Aug. 19, 1999, and entitled: “Improved Double Stop Dynamic Gas Spring,” which provisional application is incorporated herein, in its entirety, by reference.

### BACKGROUND OF THE INVENTION

The present invention relates to an improved gas spring, and more particularly, to an improved multiple stop gas spring where the movement of the gas spring shaft may be selectively stopped at one or more positions, intermediate and during the shaft's normal stroke of travel, and additionally or alternatively, may be decelerated before it comes to its normal, prescribed mechanical stop at the end of its normal stroke.

Gas springs have been used in many fields to facilitate and control the movement of movable objects with respect to relatively fixed objects. One field in which gas springs have found widespread utility is the automotive field where they have been employed to facilitate and control the movement of hatches, lids and lift gates. Generally speaking, gas springs include, among other components: a tube or cylinder that defines an internal tubular cavity extending between the ends of the tube; a metering piston assembly, which is reciprocally moveable within and which divides the tubular cavity into compression and extension working chambers; a shaft connected moveable with the piston assembly, with one end of the shaft projecting out of an end of the tubular cavity; and end closures or caps for closing the ends of the tubular cavity, with one of the end closures also including a bushing seal for the reciprocally moveable shaft as it moves with respect to the tube.

In conventional gas springs, the projecting end of the shaft may extend or retract at a nominal rate through its normal stroke due to the metering of the gas across the piston assembly. In some gas spring applications, the movement of the gas spring shaft has been decelerated—during the extension stroke of the gas spring and before the shaft is extended fully mechanically stopped by including a higher viscosity fluid in the tubular cavity. The inclusion of such fluid causes the piston assembly to slow incrementally and provides an end-of-travel “cushioned” stop. This use of the higher viscosity fluid to achieve end-of-travel damping is, however, orientation sensitive. The gas spring must be in a shaft-down orientation through its extension stroke or else the higher viscosity fluid will meter through the metering piston assembly prematurely, and the end-of-travel damping feature is lost.

In many automotive environments (for instance, when gas springs are used with hatchbacks), this required shaft-down orientation cannot be maintained. Hence, end-of-travel damping has been unavailable in such “flip over” automotive environments without significant component additions that cause the price of the gas spring systems to be increased significantly.

In conventional gas springs, the spring, or more particularly the projecting end of the shaft, extends at a nominal rate for the majority of the stroke. (This rate is determined, in large part, by the gas metering orifice in the piston assembly). The extending movement, as noted above, may be decelerated under certain circumstances before coming to a mechanical stop at the end of the stroke by including a higher viscosity fluid in the tubular cavity. However, having the shaft make intermediate stops, that is, stopping the movement of the shaft between the end of a stroke, has not been attainable without significant external component additions and features that increase the price of the gas spring system dramatically.

### SUMMARY OF THE INVENTION

It is a primary object of the present invention to provide an improved gas spring having novel structure that enables the gas spring to be capable of having the shaft make an intermediate stop(s) at one or more positions during its stroke between its fully closed and fully opened positions, and additionally or alternatively, being capable of decelerating or slowing incrementally the movement of the shaft, as the shaft approaches the end of its stroke, so as to afford a cushioned stop at the end of the stroke.

Another object of the present invention is to provide an improved gas spring of the type described where the gas spring includes a tubular cavity that has one or more sections in which the ID is different from the ID of the other remaining sections of the tubular cavity, and where the shaft of the gas spring also includes a novel second piston assembly (called the “stop piston assembly” herein) that cooperates with a different ID section to cause the shaft to make an intermediate stop and/or, additionally or alternatively, to achieve an end of travel damping of the shaft movement.

Still another object of the present invention is to provide an improved gas spring of the type described where shaft movement may continue, after an intermediate stop, by applying an external force to the shaft so as to move the stop piston assembly away from being adjacent to the different ID section.

A further object of the present invention is to provide an improved gas spring of the type described where the gas spring may be manufactured for sale at an acceptable price (particularly in the highly competitive price conscious auto industry), and is capable of making intermediate stops(s) and/or end of stroke damping, both without regard to the orientation of the gas spring and either during the extension stroke or during the compression stroke of the shaft.

A still further object of the present invention is to provide an improved gas spring of the type described where the gas spring includes a tube or cylinder that has a first closed end (which is adapted to be connected with one of a moveable object or a relatively fixed object), a second end and a tubular cavity (which extends between the tube's ends and which is adapted to be filled with gas under pressure during gas spring usage) and that has at least one first axially longitudinally extending section in the tubular cavity, with this first section having a preselected ID; a shaft that has a first end and a second end (which is adapted to be connected with the other of the moveable object or relatively fixed object), that is disposed, in part, in the tubular cavity so that the longitudinal axes of the tube and the shaft are coaxial, so that its first end is within and its second end is without the tube, and so that the shaft may reciprocally move, selectively in a first axial direction or a second axial direction, through a preselected stroke, and with respect to the tube; a bushing assembly that provides a gas seal about the shaft as the shaft moves with respect to the tube; a metering piston assembly that is connected and moveable with the shaft in the tubular cavity, and that meters the passage of gas across the metering piston assembly as the shaft and the metering piston assembly move in the tubular cavity; and where the tubular cavity has at least one second, longitudinally or axially extending section that has a preselected ID, which is different than the ID of the first section; and a second or stop piston assembly that is connected and moves with the shaft in the tubular cavity and that selectively restricts the passage of gas across the stop piston assembly when the shaft is moved in the first direction with respect to the tube and when the stop piston assembly is adjacent a second section of the tubular cavity.

A related object of the present invention is to provide an improved gas spring of the type described where the stop piston assembly is connected with the shaft a preselected distance longitudinally or axially from the metering piston assembly; and where the ID of each first section of the tubular cavity is larger than the ID of each second section of the tubular cavity. A still further related object of the present invention is to provide a gas spring of the type described where the longitudinal or axial distance between the metering piston assembly and the stop piston assembly is selected so that the metering piston assembly remains substantially adjacent to a first section of the tubular cavity during movement of the shaft through its preselected stroke.

These and other objects, benefits and advantages of the present invention will be more apparent from the following description of the drawings and the preferred embodiments of the present invention.

### BRIEF DESCRIPTION OF THE DRAWINGS

FIG. 1 illustrates the use of an improved gas spring of the present invention with a hatchback style automobile where the lift gate is in its fully open position.

FIG. 2 is similar to the illustration of FIG. 1 but where the lift gate is shown in a less than fully open position due to the gas spring having stopped in an intermediate position, that is, at a position that is less than its fully extended stroke position.

FIG. 3 is an axial, cross-sectional view of one embodiment of an improved gas spring of the present invention.

FIG. 4 is an enlarged, cross-sectional view of the stop piston assembly and the metering piston assembly of the gas spring of FIG. 3 showing the flow path of the gas passing across these assemblies during an extension stroke of the gas spring and while these assemblies are adjacent to a larger, base ID section of the tubular cavity of the gas spring tube.

FIG. 5 is a cross-sectional view, similar to FIG. 4, showing the flow path of gas passing across the stop piston assembly and the metering piston assembly during a compression stroke of the gas spring and while these assemblies are adjacent to a larger base ID section of the tubular cavity of the gas spring tube.

FIG. 6 is a cross-sectional view, similar to FIG. 4, showing the flow path of the gas passing across the stop piston assembly and the metering piston assembly during an extension stroke of the gas spring and while the assemblies are adjacent to a reduced section of the tubular cavity of the tube.

FIG. 7 is a cross-sectional view, similar to FIG. 4, showing the flow path of the gas across the stop piston assembly and the metering piston assembly during a compression stroke and while the assemblies are adjacent to a reduced ID section of the tubular cavity of the tube.

FIG. 8 is an enlarged cross-sectional view of the stop piston assembly and the metering piston assembly where the stop piston assembly is connected with the shaft so that an intermediate stop(s) and/or end-of-travel damping function may be achieved during a compression stroke of the gas spring.

FIG. 9 is a cross-sectional view, similar to FIG. 3, of the presently most preferred embodiment of a gas spring of the present invention.

FIGS. 10-12 are cross-sectional views of an illustrative tube, a flexible stop seal and a backing plate, respectively, that are components of the stop piston assembly of the present invention.

### DETAILED DESCRIPTION OF THE PREFERRED EMBODIMENTS OF THE INVENTION

Overview:

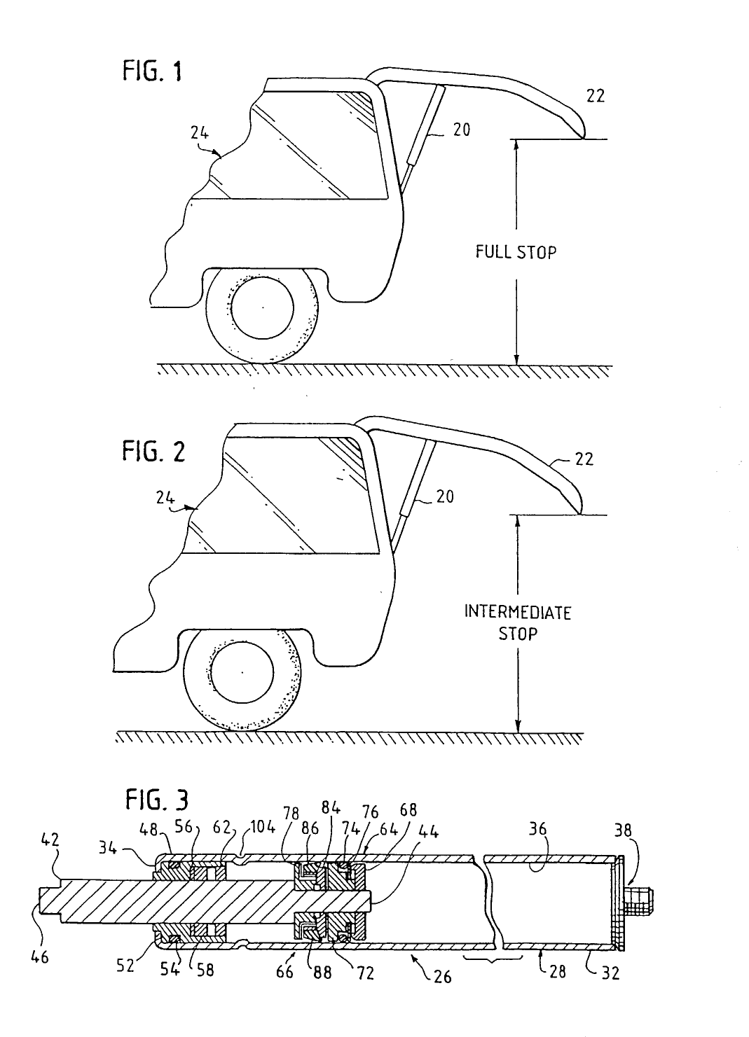

Improved gas springs of the present invention have particular utility in the automotive field because they can be relatively inexpensively manufactured and provide commercially important features not found in any previously available gas spring. As illustrated in FIGS. 1 and 2, a gas spring (indicated generally at 20) of the present invention may be employed to hold the lift gate 22 of a hatchback automobile 24 in a fully opened position (FIG. 1) or in an intermediate or partially opened position (FIG. 2). The ability to position the lift gate 22 at an intermediate position, such as shown in FIG. 2, is a desirable “selling” feature because, for example, it permits persons of shorter stature to be able to easily lift the lift gate 22 to a position where ready access can be obtained to the rear compartment of the automobile 24 while not having to strain to reach the lift gate when trying to close the gate.

The lift gate 22 can be moved from a closed position to the intermediate position, as shown in FIG. 2, by opening the lift gate latch and pushing, in a normal manner, the lift gate upwardly. The lift gate 22 then stops at this intermediate position “automatically,” that is, without any further effort on the part of the person. If for some reason it is a desire to move the lift gate from the intermediate position, shown in FIG. 2, to the fully open position, shown in FIG. 1, the person need only briefly apply external force to the lift gate, and the gas spring will then move the lift gate 22 from its intermediate position to its fully open position. Another advantageous feature of the improved gas spring of the present invention is that the lift gate 22, whether in its intermediate or fully open position, may be returned to a closed position in the same manner and using the same force that would be required if a conventional gas spring had been employed instead.

Gas springs of the present invention are also capable of providing end-of-travel damping or slowing down of the rate of movement of the lift gate 22 as it moves to its fully open position. This, too, is an advantageous “selling” feature since it prevents the jarring and shaking of the lift gate as it is mechanically stopped when the lift gate reaches its fully opened position.

To achieve these commercially important, consumer pleasing advantages, the improved gas spring of the present invention incorporates a tubular cavity that has a variation(s) in its inside diameter or ID profiles so as to provide stopping zones or sections and/or deceleration or damping zones or sections. In other words, the ID's of one or more sections or zones of the tubular cavity are varied with respect to the other section(s) or zone(s). In this regard, the tubular cavity may initially have a uniform, “base” ID, and in certain selected sections, the ID is preferably reduced vis-a-vis the “base” ID.

ID profile variations are formed by expanding or be reducing the tube. Tube expansion or reduction may be accomplished by the use of several means, such as form rollers, hydroforming, or expanding mandrells, on the surface of the tubing so as to reduce or expand the tubular cavity ID by a preselected dimension. This cylindricity of the tube is maintained throughout the process by incorporating appropriate fixturing which prevents the tube from deforming outside of the specific ID sections.

A novel piston assembly, called a stop piston assembly herein, is adapted to cooperate with the reduced tube ID (when the shaft is moving in one direction, normally, its extension direction) section so as to provide a necessary sealing action for an intermediate stop and/or for an end-of-travel damping. A good sealing interface between the stop piston assembly and the reduced ID section is required whenever and wherever an intermediate stop or damping is desired.

Any number of expanded or reduced ID sections may be incorporated in an improved gas spring of the present invention. The number of such sections will be determined by the requirements of the application to which the gas spring is to be employed.

As noted, the improved gas springs of the present invention may have reduced ID sections which will provide for intermediate stopping of the movement of the shaft and/or will provide end-of-travel damping regardless of orientation of the gas spring. The latter reduced ID sections causes the shaft to slow incrementally as the shaft approaches its end-of-stroke, that is, is about to be mechanically stopped in a conventional manner.

The degree of reduction of the ID in a reduced ID section relates to a reduction in the velocity of the spring's extension (or compression) rate of movement through the section. The basic operation of the improved gas spring of the present invention is identical whether the reduced ID section is intended to bring the gas spring to an intermediate stop or to dampen the movement of the gas spring. Preferably, however, achieving a damping function requires a smaller pressure differential, that is, requires a smaller reduction in the ID of the section as compared to the base ID of the tubular cavity (In practice, the same ID reduction may be used to achieve both the intermediate stop and damping functions).

The damping of the movement of the gas spring shaft does not have to occur only at or near the end of the stroke of the shaft. Rather this damping function, like the stopping function, may be located anywhere within the tubular cavity. In other words, the precise location of a reduced ID section for achieving an intermediate stop function or damping function may be readily accomplished anywhere along the length of the tube (within the travel range), and thus along the stroke of the shaft, forming different ID profiles for the appropriate function at the desired locations.

A novel and intentional feature of the stop piston assembly of the present invention, which cooperates with the reduced ID sections of the tubular cavity to achieve an intermediate stop and/or damping function(s), is functional in only one direction. In other words, if the stop piston assembly is used to provide these functions during the extension stroke, then the stop piston assembly is functionally “invisible” during the dynamic compression stroke, that is, the assembly does not cooperate with the reduced ID section(s) to provide any damping and/or intermediate stopping function during the compression stroke. Alternatively, the stop piston assembly may be used so as to provide an intermediate stop and/or damping function(s) during the compression stroke of the gas spring, but when so used, is functionally “invisible” during the extension stroke, that is, the stop piston assembly does not cooperate with the reduced ID section(s) to provide for an intermediate stop and/or damping function during the extension stroke.

When the stop piston assembly is used to afford an intermediate stop and/or damping function during the compression stroke, the gas spring would be employed in application(s) that would or should require a greater force to compress the gas spring through a portion of its stroke and then return it to standard or normal operation. Thus, this gas spring might be used as a semi-locking device, holding an object up or open and requiring a greater than normal force to initiate a closing motion. Additionally, the stop piston assembly could be made so that it would intentionally have a stopping function in both directions of travel, such as a bi-direction stopping function, would have utility with, for instance, tanning bed covers.

As will be described in more detail hereinafter, the novel stop piston assembly may be disposed or positioned adjacent a metering piston assembly. It is, however, presently most preferred that the stop piston assembly be spaced longitudinally or axially from the metering piston assembly, and that the spacing be selected so that, to the extent practical, the metering piston assembly does not ever become adjacent to or in contact with a reduced ID section of the tubular cavity. So, separating the two piston assemblies affords a significant improvement in the number of cycles to failure. This improvement was achieved, it is believed, because of reduced side loading on the seals in the gas spring and results in a longer seal life and longer acceptable gas and oil leakage.

More Detailed Description:

Turning now to FIGS. 3-7, an improved gas spring 26 of the present invention includes a cylindrical tube 28 that has a first end 32 and a second end 34. The tube 28 includes a tubular cavity 36, which is adapted to be filled with gas under pressure as is conventional in the gas spring art. A conventional end cap 38 closes and seals the first end of the tube 28.

The gas spring 26 also includes a reciprocally moveable shaft 42. As is conventional, the shaft is disposed, in part, in the tubular cavity 36 so that the longitudinal axes of the shaft and the tubular cavity are coaxial. The shaft has a first end 44, which is adjacent to the first end 32 of the tube 28 and a second end 46, which projects out of the tube.

A conventional bushing assembly 48 is disposed adjacent the second end 34 of the tube and surrounds the shaft 42 so as to provide a gas and oil seal for the shaft as the shaft reciprocally moves within the tube 28 in a conventional manner. The bushing assembly 48 includes a front bushing 52, an O-ring 54, a Teflon® washer 56, an annular front seal 58 and an annular bushing back 62, which may be optional. The bushing 52 is generally cup-shaped, with an open end of the “cup” facing to the right and the closed base of the “cup” facing to the left, as seen in FIG. 3. The “O” ring 54 seals between the bushing 52 and the ID of the tubular cavity, adjacent the end 34. The washer 56 is disposed about the shaft 42 and between the right facing surface (as seen in FIG. 3) of the bottom of the “cup” of bushing 52 and the front seal 58, which is also disposed about the shaft and within the “cup” of bushing 52. The optional bushing back 62 is axially spaced, rightward (as seen in FIG. 3) from the seal 58, is disposed about the shaft, and is supported in the distal end of the bushing 52 “cup.”

Two piston assemblies, that is, a metering piston assembly 64 and a novel stop piston assembly 66, are both connected with and moveable with the shaft 42. More particularly, and as shown in FIG. 3, the assembly 64 is connected with the front end 44 of the shaft. The metering piston assembly 64 may be of conventional design and function and serves to divide the tubular cavity 36 into an extension working chamber, which is between the assembly 64 (and the assembly 66) and the end 34, and a compression working chamber, which is between the assembly 64 and the end 32. The assembly also functions to meter the flow of gas past the metering piston assembly as the assembly 64 moves, with the shaft 42, in the tubular cavity 36.

As shown in FIGS. 3-7, the assembly 64 includes an orifice plate 68 and an O-ring shuttle valve 72. The shuttle valve 72 includes an annular recess that faces the orifice plate 68 and receives therein an O-ring 74. A washer 76 is disposed between the O-ring 74 and the facing (left in FIG. 3) side of the plate 68. The relative dimensions of the orifice in the plate 68, valve 72, O-ring 74 and washer 76 determine the rate at which gas can be metered or passed across the assembly 64.

As noted, the stop piston assembly 66 is of novel design and construction and serves to permit the gas to pass freely, without significant metering across the assembly 66 when the assembly is adjacent those sections of the tubular cavity 36 which have a “base” ID, that is, the ID that would be present if only the metering piston assembly were connected with the shaft 42. The base ID is indicated at ID1 in FIG. 10.

The stop piston assembly 66 includes an annular stop seal shuttle valve member 78 that abuts a shoulder on the shaft 42 and is adjacent to the end 46 of the shaft. The member 78 includes a radially extending portion 80, which abuts the shaft shoulder, and a central portion 82 that projects toward the end 32 of the tube. The OD of the portion 80 is slightly less than the ID of any section of the tubular cavity, and the OD of the portion 82 is less than the OD of the portion 80. A backing plate 84 is mounted on the shaft adjacent to the distal end of the central portion 82, that is, the end closest to the tube end 32. An annular, resilient stop seal 86 is mounted about the central portion 82 such that the seal 86 can relatively freely move axially or shuttle with respect to the portion 82 between the plate 84 and the portion 80. The axial length of the central portion 82 is greater than the axial thickness of the stop seal 86 so that the stop seal 86 may move or shuttle axially between a position where it is adjacent and in contact with the backing plate 84 and a position where it is in contact with the portion 80 of the member 78. This shuttling action will be described in further detail hereinafter.

The OD of the metal backing plate 84 is less than the OD of the seal 86 so that when the seal and backing plate 84 are adjacent and in contact with each other, the backing plate 84 supports or reinforces a central portion of the seal 86. The annular outer portion 88 of the seal 86 is flexible and includes an axially extending, radially outwardly extending lip 92 which, as shown in FIGS. 3-7, is adapted to face and overlay adjacent the curved annular surface 90 of the backing plate 84, which is cut away to support the flexing of the lip portion 92. An O-ring 94 is mounted in the plate 84 and serves to seal about the shaft 42.

As explained above, the ID of the tubular cavity 36 may be reduced in a preselected section(s) or zone(s), such as sections 96 and 98 (whose ID's are indicated by ID2 in FIG. 10), so that in these sections, 96 and 98, the lip portion 92 of the stop seal 86 may come into sealing contact with the ID of the section so as to cause an intermediate stop (section 96) and/or damping (section 98) of the movement of the shaft with respect to the tube. In other or base sections of the tubular cavity 36, such as sections 102, shown generally in FIG. 10, the ID of the sections 102 (which ID's are indicated at ID1 in FIG. 10) is selected so that the lip portion 92 cannot come into sealing contact with the ID of the section 102. In these latter sections 102, the movement of the shaft proceeds as in a conventional gas spring since the stop piston assembly 66 has no functional effect on the operation of the gas spring.

As is conventional, the stop groove or radially inward projection 104 formed in the tube 28, adjacent the bushing assembly 48. The stop groove 104 has an ID, which is smaller than the ID's of sections 96 and 98, and which is indicated by ID3 in FIG. 10, and serves to mechanically stops the shaft 42, and the end of its stroke, by the contact between the end portion 80 of the valve member 78 and the groove 104. By having a damping section 98 adjacent to the groove 104 (that is, to the right of the groove as shown in FIG. 3), the shaft will come to a cushioned stop just as the portion 80 comes into contact with the groove 104.

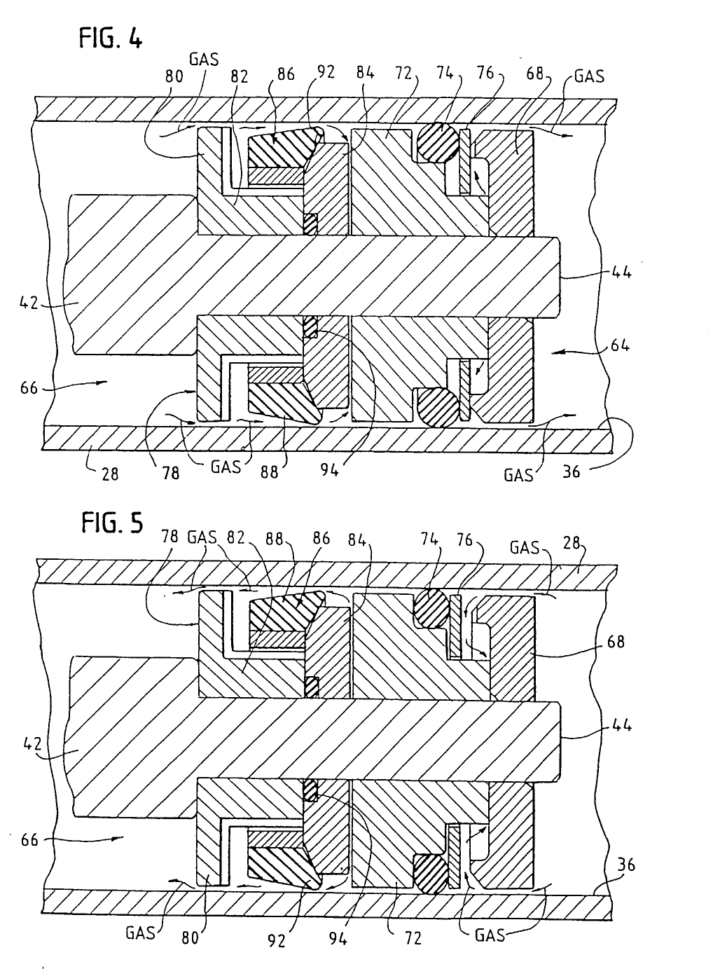

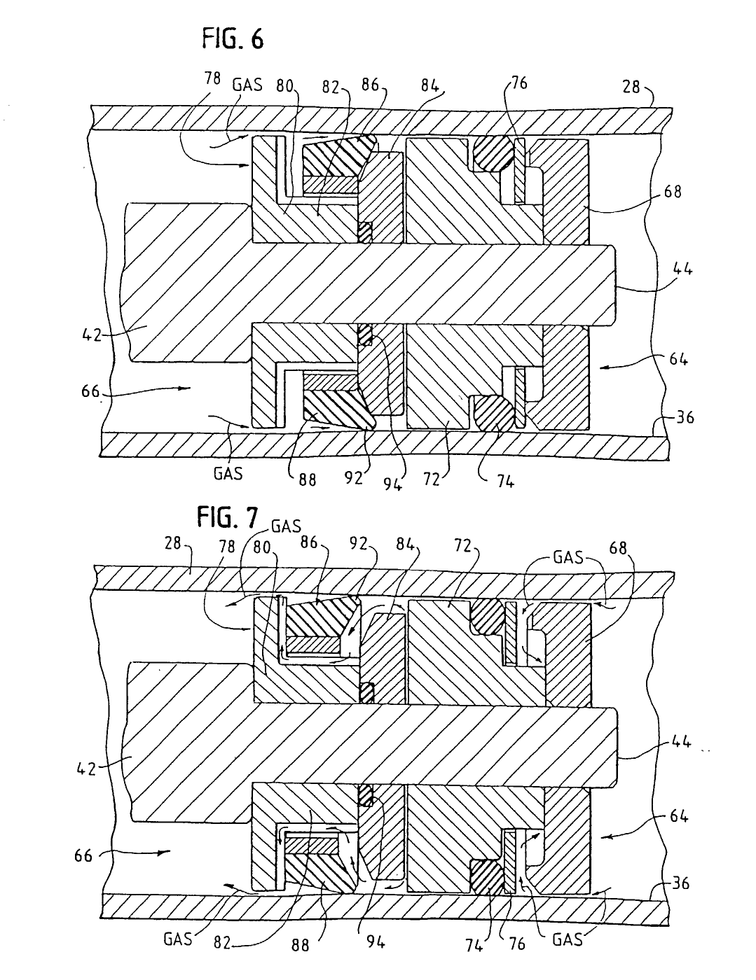

FIGS. 4 and 5 illustrate how the gas in the tubular cavity 36 may pass across both the metering piston assembly 64 and the stop piston assembly 66 when the shaft is moved in the extension direction (FIG. 4) and in the compression direction (FIG. 5) while these assemblies are in or adjacent a base ID section, such as the section 102. FIG. 6 illustrates how the reverse stop seal 86 and backing plate 84 cooperate so that the lip portion 92 will block the passage of the gas across or past the assembly 66 when the shaft 42 is moved in the extension direction, and the stop piston assembly 66 is adjacent a stop or damping section, such as the sections 96 and 98, respectively. FIG. 7 illustrates how the gas is able to pass across both the assemblies 64 and 66 when the shaft 42 is moved in a compression direction even though the assemblies are disposed in or adjacent to a stop or a damping section, such as sections 96 and 98, respectively. In this latter instance, that is, when the shaft 42 is moved in the compression direction while the stop piston assembly 66 is adjacent to a section 96 and/or section 98, the stop seal 86 shuttles axially away from contact with the backing plate 84 and into contact with the portion 80 of the member 78 so that gas can pass in the annular space between the ID of the seal 86 and OD of the portion 82 of the member 78.

As noted above, the most preferred embodiment of the present invention is a gas spring in which the metering piston assembly 64 is connected with the shaft 42 at or substantially at the end 44 of the shaft 42 and in which the stop piston assembly 66 is connected with the shaft 42 an axial distance from the end 44, toward the end 46 of the shaft. Such a gas spring 106 is illustrated in FIG. 9.

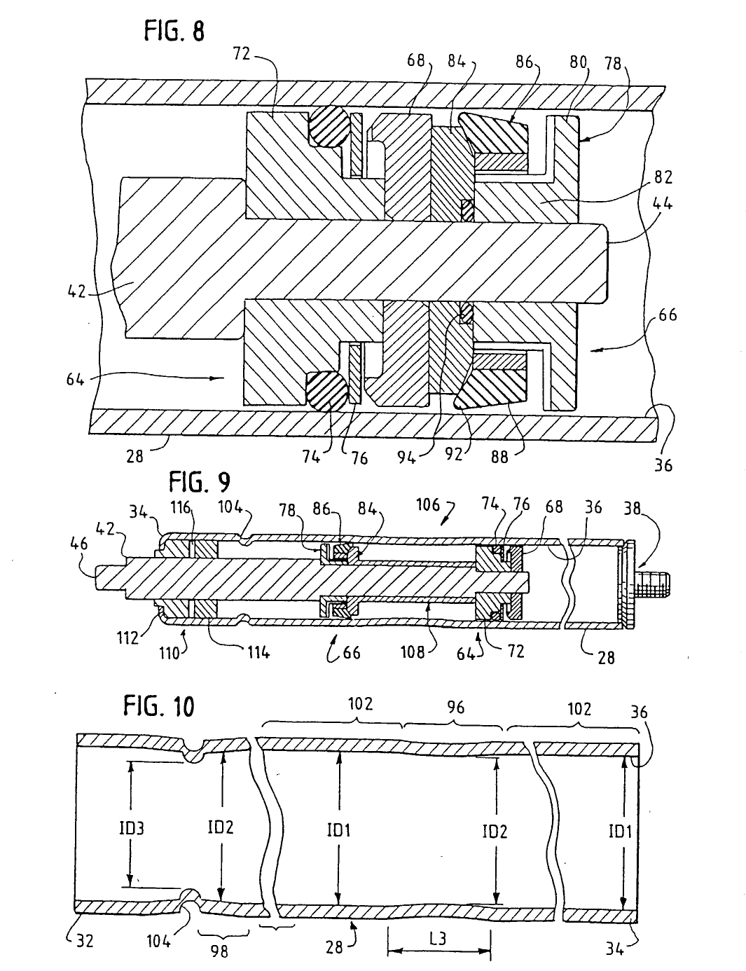

The gas spring 106 is structurally and functionally identical to the gas spring 26, as shown in FIGS. 3-7 (and the stop piston assembly 66 may also be employed as in FIG. 8), except as noted below and except for the distance or axial spacing between the assemblies 64 and 66. The backing plate 84 includes an integral, annular, axially extending portion 108 that fits about the shaft 42 and that extends between the plate 84 and shuttle valve 72. The OD of the portion 108 may be approximately the same as the OD of the central portion 82 of the valve member 78.

Preferably, the distance or axial spacing between the assemblies 64 and 66 is selected so that, during all or as much as possible, of the stroke, the metering piston assembly 64 will remain adjacent to section 102 (that is, a section having a base ID). Selecting such a distance or spacing, and thus reducing the travel of the assembly 64 through reduced ID sections 96 and 98 minimizes the side loading on, and hence wear on the seals. This results in longer part lives and reduced gas and oil leakage.

As shown in FIG. 9, the gas spring 106 includes an alternative, conventional front bushing assembly 110. Specifically, the assembly 110 includes a front bushing 112, which is adjacent the end 34 of the tube 28, and a front seal 114, which is disposed adjacent the stop groove 104. A Teflon® washer 116 is disposed between the bushing 112 and the front seal 114. The bushing assembly 110 functions, like the assembly 48, to provide a gas and oil seal around the shaft 42 and at the end 34 as the shaft reciprocates and when the shaft is stationary. The assembly 110 may be used interchangeably with the assembly 48.

As noted above, the stop piston assembly 66 may be disposed on the shaft 42 such that it will function to cause movement of the shaft to stop or dampen when the shaft is moved in the compression direction as opposed to the extension direction. As shown best in FIG. 8, the assembly 66 contains the same components when it is used to stop or dampen the shaft moving in the compression direction as when the stop piston assembly 66 is used to achieve or use a dampening function in the extension direction. As illustrated in FIG. 8, however, the components of the stop piston assembly 66 are in a reversed (mirror image) arrangement when used to provide the stop or damping functions when the shaft 42 moves in the compression direction.

The stop piston assembly 66 provides an intermediate stop and/or damping function due to the creation of a prescribed pressure differential caused by the contact between the lip portion 92 of the seal 86 and the ID of the tubular cavity in those sections 96 and 98 that have a reduced diameter or ID. The desired pressure differential is determined by the geometry of the stop seal 86, the properties of the stop seal material, and the diameter and shape of the supporting backing plate 84. By increasing the OD of the backing plate 84, the lip portion 92 will stand higher pressures before deforming and bypassing due to a pressure differential. By reducing the OD, the lip portion 92 will deflect and bypass at a lower pressure differential. The use of the plate 84 with the seal 86 allows those working in this art to “tailor” the stop piston assembly 66 for individual gas spring applications.

Also, and as noted above, the intermediate stop position of the gas seal of the present invention is a function of the location of the reduced ID section, such as sections 96 and 98. Another feature of the improved gas spring of the present invention and particularly the stop piston assembly 66 is the shuttling action of the seal 86. This shuttling feature permits the stop and damping functions to be “invisible” (to a user) when the shaft is moved in the direction other than the direction in which those functions are intended to be achieved. This shuttling is achieved by utilizing the difference between the OD of the lip portion 92 and the ID of the reduced ID sections, such as sections 96 and 98, to “pull” the seal off of the backing plate 84 and thereby allow a hatch or lid, for example, to be shut quickly and easily without the intermediate stop or damping.

As also noted above, once the stop piston assembly 66 is adjacent to the stop section (such as section 96) so as to cause an intermediate stop in the shaft movement, an externally extending force (assuming that the stop piston assembly 66 is being used to function in the shaft extension direction) may be applied to the end 46 of the shaft 42 so that the stop piston assembly 66 is pulled axially beyond the section 96. The gas spring 26 then extends normally since the gas can once again pass across the stop piston assembly 66 and the assembly 64. The force required to “pull” the stop piston assembly 66 across a stop section 96 is a function of: the length of the stop section 96, the net effective force of the gas spring on the application such as the hatch, the portion of gas volume on the shaft side of the stop piston assembly 66 vs. the non-shaft side of the stop piston assembly 66, and the OD of the backing plate 84.

The seal 86 preferably be made from a material that has a predictable force/pressure balance to counter a differential pressure applied across it. Such materials may include EPDM (the presently preferred material), elastomeric material, rubber, TPR, etc. Any material used for the seal 86 should provide a near absolute seal in stop sections, such as section 96. A differential pressure creates a robust stop.

While particular elements, embodiments and applications of the present invention have been shown and described, it will be understood that the present invention is not limited to these descriptions and showings since modifications can be made by those skilled in the art, particularly in light of teachings herein. It is therefore contemplated that the appended claims will incorporate all such modifications that fairly come within the spirit and scope of the invention.

What is claimed:

1. In a gas spring adapted to be connected between a movable object and relatively fixed object and to be used to facilitate and control the movement of the movable object with respect to the relatively fixed object, where the gas spring includes: a tube that has a first closed end which is adapted to be connected with one of the movable objects or the relatively fixed object, a second end, and a tubular cavity which extends between the first and second ends of the tube and which is adapted to be filled with gas under pressure during usage of the gas spring, and that has a longitudinal axis extending between the first and second ends, that has at least one first, longitudinally extending section in the tubular cavity with the first section having a preselected ID; a shaft that has a first end and a second end which is adapted to be connected with the other of the movable object or the relatively fixed object, that has a longitudinal axis extending between the first and second ends of the shaft, and that is disposed, in part, in the tubular cavity so that the longitudinal axis of the tube and shaft are coaxial, so that the first end of the shaft is within the tubular cavity, so that the second end of the shaft is disposed without the tube, and so that the shaft may reciprocally move, selectively in one of a first axial direction or a second axial direction, through a preselected stroke, and with respect to the tube; a bushing assembly that is disposed adjacent to the second end of the tube and that provides a gas seal about the shaft as the shaft moves with respect to the tube; and a metering piston assembly that is disposed in the tubular cavity, that is connected with and movable with the shaft, and that meters the passage of gas across the metering piston assembly as the shaft and metering piston assembly move in the tubular cavity, the improvement comprising: the tubular cavity having at least one second, axially extending section that has a preselected ID, which is different than the ID of the first section; and a second piston assembly that is disposed in the tubular cavity, that is connected with and moves with the shaft, and that selectively restricts the passage of gas across the second piston assembly when the shaft is moved in the first direction with respect to the tube and when the second piston assembly is adjacent a second section of the tubular cavity.

2. The gas spring of claim 1 wherein the metering piston assembly is connected with the first end of the shaft; wherein the second piston assembly is connected with the shaft a preselected distance axially from the metering piston assembly; and wherein the ID of each first section of tubular cavity is larger than the ID of each second section of the tubular cavity.

3. The gas spring of claim 2 wherein the axial distance between the metering piston assembly and the second piston assembly is selected so that the metering piston assembly remains substantially adjacent to a first section of the tubular cavity during movement of the shaft through the preselected stroke.

4. The gas spring of claim 3 wherein a second section of the tubular cavity is adjacent one end of the tube; and wherein the restriction in the passage of gas across the second piston assembly is selected so that the rate of movement of the shaft in the first direction is caused to slow incrementally to a cushioned stop when the second piston assembly moves adjacent to the second section and as the shaft approaches the end of the preselected stroke.

5. The gas spring of claim 3 wherein a second section of the tubular cavity is between the ends of the tube; wherein the tubular cavity includes two first sections, with one first section being between the second section and one end of the tube and with the other first section being between the second section and the other end of the tube; and wherein the restriction in the passage of gas across the second piston assembly is selected so that movement of the shaft in the first direction is stopped when the second piston assembly moves, in the first direction, from adjacent the one first section to adjacent the second section of the tubular cavity.

6. The gas spring of claim 5 wherein the movement of the shaft in the first direction may continue when, through an application of an external force to the shaft, the second piston assembly is moved in the first direction from adjacent to the second section of the tubular cavity to adjacent to the other first section of the tubular cavity.

7. The gas spring of claim 5 wherein a third piston assembly is disposed in the tubular cavity, is connected with and moves with the shaft, and selectively restricts the passage of gas across the third piston assembly when the shaft is moved in the second direction with respect to the tube and when the third piston assembly is adjacent a second section of the tubular cavity.

8. The gas spring of claim 3 wherein the tubular cavity includes two second sections, with one first section being adjacent to one end of the tube and with the other first section being between the ends of the tube; wherein the restriction in the passage of gas across the second piston assembly is selected so that the rate of movement of the shaft in the first direction is caused to slow incrementally to a cushioned stop when the second piston assembly moves adjacent to the one second section and as the shaft approaches the end of the preselected length of the one end of the tube; wherein the tubular cavity includes two first sections, with one first section being between the other second section and with the other end of the tube and the other first section being between the other second section and the one second section of the tubular cavity; and wherein the restriction in the passage of gas across the second piston assembly is selected so that movement of the shaft in the first direction is stopped when the second piston assembly moves from adjacent the one first section to adjacent to the other second section of the tubular cavity.

9. The gas spring of claim 8 wherein the movement of the shaft may continue when, through the application of an external force to the shaft, the second piston assembly is moved in the first direction from adjacent to the other second section of the tubular cavity to adjacent to the other first section of the tubular cavity.

10. The gas spring of claim 3 wherein a third piston assembly is disposed in the tubular cavity, is connected with and moves with the shaft, and selectively restricts the passage of gas across the third piston assembly when the shaft is moved in the second direction with respect to the tube and when the third piston assembly is adjacent a second of the tubular cavity.

11. The gas spring of claim 3 wherein movement of the shaft in the first direction causes the second piston assembly to move away from the first end of the tube and toward the second end of the tube.

12. The gas spring of claim 3 wherein movement of the shaft in the first direction causes the second piston assembly to move away from the second end of the tube and toward the first end of the tube.

13. The gas spring of claim 4 wherein the other end of the tube is the first end of the tube and the one end of the tube is the second end of the tube; and wherein movement of the shaft in the first direction causes the second piston assembly to move away from the first end of the tube and toward the second end of the tube.

14. The gas spring of claim 4 wherein the one end of the tube is the first end of the tube and the other end of the tube is the second end of the tube; and wherein movement of the shaft in the first direction causes the second piston assembly to move away from the second end of the tube and toward the first end of the tube.

15. The gas spring of claim 6 wherein the other end of the tube is the first end of the tube and the one end of the tube is the second end of the tube; and wherein movement of the shaft in the first direction causes the second piston assembly to move away from the first end of the tube and toward the second end of the tube.

16. The gas spring of claim 6 wherein the one end of the tube is the first end of the tube and the other end of the tube is the second end of the tube; and wherein movement of the shaft in the first direction causes the second piston assembly to move away from the second end of the tube and toward the first end of the tube

17. The gas spring of claim 9 wherein the other end of tube is the first end of the tube and the one end of the tube is the second end of the tube; and wherein movement of the shaft in the first direction causes the second piston assembly to move away from the first end of the tube and toward the second end of the tube.

18. The gas spring of claim 9 wherein the one end of the tube is the first end of the tube and the other end of the tube is the second end of the tube; and wherein movement of the shaft in the first direction causes the second piston assembly to move away from the second end of the tube and toward the first end of the tube.

19. The gas spring of claim 3 wherein the second piston assembly includes resilient, radially outwardly extending lip seal that has a preselected OD and that has a central body portion and an annular lip portion, which extends radially outwardly from the body portion; wherein a backing plate is disposed adjacent to the body portion of the lip seal to support the body portion of the lip seal, and has an OD which is less than the OD of the lip seal; and wherein the OD of the lip portion of the lip seal is selected so that when the shaft is moved in the first direction, the lip portion of the lip seal is capable of providing a gas seal between the OD of the second piston assembly and the ID of a second section of the tubular cavity and is incapable of providing a gas seal between the OD of the second piston assembly and the ID of a first section of the tubular cavity.

20. The gas spring of claim 19 where the lip seal is movable longitudinally, with respect to the second piston assembly between a first position in which the lip seal is capable of providing a gas seal between the OD of the second piston assembly and the ID of a second section of the tubular cavity, and a second position in which gas may pass across the second piston assembly without restriction from the lip seal.

21. The gas spring of claim 20 wherein the lip seal is moved to the first position when the shaft moves in the first direction; and wherein the lip seal is moved to the second position when the shaft moves in the second direction.
